(19) United States
(12) Patent Application Publication
(10) Pub. No.: US 2009/0302123 A1
(43) Pub. Date: Dec. 10, 2009

(54) METHOD OF CODED MARKING OF A PRODUCT OF SMALL SIZE, AND MARKED PRODUCT OBTAINED ACCORDING TO SAID METHOD

(75) Inventors: Eric Lugt, Rances (CH); Abdul-Hamid Kayal, Neuchatel (CH)

Correspondence Address: GRIFFIN & SZIPL, PC, SUITE PH-1, 2300 NINTH STREET, SOUTH, ARLINGTON, VA, 22204, US

(73) Assignee: MONTRES BREGUET SA, L'abbaye (CH)

(21) Appl. No.: 12/159,252

(22) PCT Filed: Dec. 22, 2006
(86) PCT No.: PCT/EP06/70157

§ 371 Date: Nov. 25, 2008

(30) Foreign Application Priority Data
Dec. 29, 2005 (EP) 05113072.2

(51) Int. Cl. G06K 19/06

(52) U.S. Cl. 235/494

(57) ABSTRACT

The method is for coded marking of a product of small size, such as horological or jewelry product (10). The method consists in carrying out a first mathematical operation of encrypting an identifier (13), such as a serial number of the product to be marked using a specific security algorithm key to obtain a first authenticator. The first authenticator includes a first data length defined by a first large number of alphanumerical characters. This first authenticator is encrypted using a second mathematical operation using a Hash type function into a second authenticator. This second authenticator includes a second data length defined by a second reduced number of alphanumerical characters shorter than the first number of characters. The second authenticator is converted into a coded image, which is preferably a two dimensional barcode (11) so as to be placed on the product as the coded mark in order to allow said product to be authenticated.

This is a National Phase Application in the United States of International Patent Application No. PCT/EP2006/070157 filed Dec. 22, 2006, which claims priority on European Patent Application No. 05113072.2, filed Dec. 29, 2005. The entire disclosures of the above patent applications are hereby incorporated by reference.

### FIELD OF THE INVENTION

The present invention concerns a method of coded marking of a product of small size, such as a horological or jewelry product so that it can be authenticated.

A product of small size means any product of instrument of the size of a watch or the components thereof, a necklace, a bracelet, a ring, a precious stone or other instruments.

### BACKGROUND OF THE INVENTION

In order to prevent counterfeiting of products, particularly luxury goods, such as horological or jewelry products, a coded mark or indication must be placed on each product in order to authenticate and identify it. This coded mark may be placed during the manufacturing process of the product in order to guarantee the authenticity of the manufactured product thereafter. The coded mark placed on said product must also not have large dimensions so as to not detract from the aesthetic appearance of the product if the mark is placed on an external part of the product that is visible to the naked eye.

In order to do this, various marking methods have already been proposed in the past for ensuring such specific identification and authentication of said product. The coded mark can be camouflaged on the product or form part of other marking indications. The coded mark may also be based on an identifier of said product, which may be the serial number attributed to the product during the manufacturing process. This identifier is then encrypted generally by a usual encryption algorithm so as to obtain an authenticator formed of several alphanumerical characters, the number of characters of which is often a function of the dimension of the encryption key used.

One may cite in this regard EP Patent No. 0 889 448, which discloses a method of preventing the counterfeiting of luxury goods, such as watches. Each watch can comprise a coded mark, which is etched on one part of the watch. This mark is formed of an identifier relating to a serial number of the product and an encrypted portion. The encrypted portion is obtained using part of the information relating to the watch, which is encrypted by a private key of one algorithm with a pair of private and public keys. Via said algorithm, the public key enables the encrypted portion to be decrypted in order to find the piece of information.

One drawback of this method of EP Patent No. 0 889 448 is that only one part of the watch information is used and not all of the identifier, which is for example the product serial number, to obtain the encrypted portion. Moreover, even with one part of the identifier, the dimension of the encrypted portion obtained using the algorithm is too large to be able to be placed on a product of small size in order to guarantee greater security against counterfeiting.

Converting an authenticator, which includes a large number of alphanumerical characters obtained via a usual encryption algorithm on the basis of a product serial number, into a two dimensional barcode, is also known. This two dimensional barcode is of smaller dimensions than all of the alphanumerical characters of the authenticator. However, the barcode is still too large to be able to be placed on a product of small size and easily read by a simple digital barcode reader.

It is a main object of the present invention to provide a method of coded marking of a product of small size to overcome the drawbacks of the aforecited prior art and to guarantee greater authentication security for said manufactured product in order to prevent any counterfeiting.

### SUMMARY OF THE INVENTION

The present invention therefore concerns a method of coded marking of a product of small size of the type cited above, which includes the features mentioned in claim 1.

Particular advantageous steps of the method are defined in the dependent claims 2 to 9.

One advantage of the method for coded marking of a product of small size lies in the fact that it enables a product to be authenticated in a reliable manner, particularly a luxury product, by using a second converted authenticator of reduced size, which is obtained on the basis of a product identifier. In order to obtain the coded image of the second authenticator on the basis of the identifier, which may be the product serial number, a first mathematical operation of encrypting the identifier has to be carried out using a key of a specific security algorithm, and a second mathematical encryption operation has to be carried out using a Hash type function. Preferably, an asymmetrical security algorithm with a pair of private and public keys is used.

Owing to the double encryption operation, this guarantees greater security against any counterfeiting of a luxury product, such as horological or jewelry products. The double encryption operation, with particularly the Hash function, does not allow the identifier to be found on the basis of the second authenticator obtained Moreover, this allows a second converted authenticator of reduced size to be obtained, that can even be placed on the outside of said product without detracting from its aesthetic appearance. The surface of the coded image, which is preferably a two dimensional barcode, can be less than 1 mm², for example 0.36 mm². This barcode of reduced size can easily be read by a conventional digital barcode reader or can also be examined under a magnifying glass without any problem.

Preferably, in order to make a coded mark on a watchcase, the coded mark can be placed between the horns of the case to be hidden by one end of the strap or bracelet mounted between the horns. An additional coded mark can also be placed on an inner part of the case in combination with a logo of the watch brand. A print of the coded mark combined with the watch brand logo can be made in the material of the case. Moreover, the serial number can complete the coded mark and the watch brand logo to form a coded imprint. This coded mark can also be made on the watch movement, on the watch dial and eventually on the time indicating hands.

Advantageously, the first authenticator includes a large number of characters dependent on the large size of the specific algorithm key to guarantee increased security. The asymmetrical type algorithm uses a private key. This large number of characters obtained can be placed on a product identification card, which may be supplied with the product being sold. This first authenticator can also be converted into a two dimensional barcode in order to be placed on said card. With the first authenticator, it is possible, with the public key of the asymmetrical algorithm, to find the initial identifier. This first authenticator may also be supplied or calculated by the factory that manufactured said product or by an authentication center for the sake of security, which has the private algorithm key. However, with the second authenticator which may or may not be converted into a two dimensional barcode, it is not possible to find the identifier.

Advantageously, the coded mark or indication in the form of a two dimensional barcode can be imprinted or etched in the material of the product. Etching can be achieved by laser beam. An additional signature to the coded indication can also be obtained as a function of a programmed etching depth using the laser beam. During a read operation by a coded mark laser beam reader, said signature belonging to the marking laser can be determined in addition to the simple two dimensional barcode reading. In this way, additional security can be obtained for authenticating the luxury product.

The present invention thus also concerns a product of small size marked using the coded marking method, which includes the features mentioned in claim 10.

Particular advantageous embodiments of the product are defined in the dependent claims 11 and 12.

### BRIEF DESCRIPTION OF THE DRAWINGS

The objects, advantages and features of the method of coded marking of a product of small size will appear more clearly in the following description, made in a non-limiting manner with reference to the drawings, in which:

FIG. 1 shows schematically a flow diagram of various steps of the method of coded marking of a product of small size according to the invention, and

FIG. 2 shows a watch case as a product of small size, on which one or two coded marks are placed combined with a case serial number and/or a watch brand logo made via the marking method of the invention.

### DETAILED DESCRIPTION OF THE ILLUSTRATIVE EMBODIMENTS

In the following description, reference is made only to the coded marking of a horological or jewelry product, even though any other product of small size can be marked in accordance with the coded marking method according to the invention. Since the various encryption operations used in said coded marking method are known by those skilled in this technical field, they will only be described in a simplified manner.

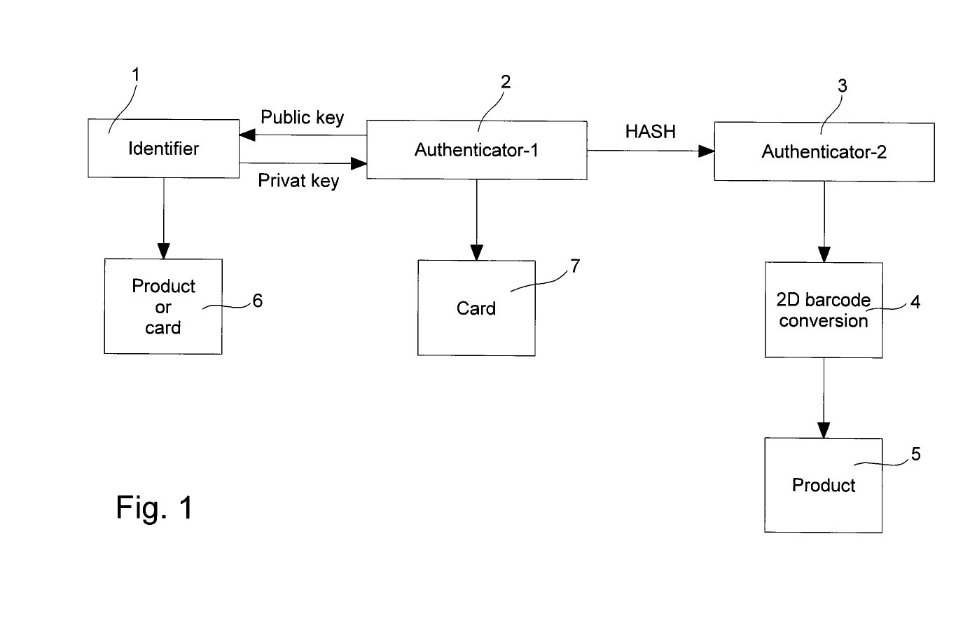

FIG. 1 shows schematically the main steps of the method of coded marking of a product of small size, such as a horological product. At step 1, an identification number is first attributed to the horological or jewelry product by a standard (MRP) production management or distribution management system, such as for example the SAP, Navision or other. This identification number is theoretically unique for each product. It may be composed of a series of alphanumerical characters of a length suited to the production reporting and status control system. This identifier can be directly printed or etched on said product to be tracked and controlled, at step 6, or marked on a product identification card, which may be supplied with the product being sold.

A first mathematical operation is carried out to encrypt the identifier of the product to be marked, using a conventional asymmetrical mathematical encryption algorithm (RSA, DH, EC or other), which may or may not be combined with a conventional symmetrical encryption (AES, DES or other). In order to guarantee the highest level of security, an asymmetrical algorithm with a pair of public and private keys, for example of the RSA type, will be chosen, to obtain a first authenticator at step 2 by encrypting the identifier using the private key. A private key of length, for example, of 1024 bits, is preferably used, since the longer the key, the more extreme the probability of obtaining two identical first authenticators from two different identifiers (around 10⁻³⁰⁸).

The first authenticator obtained at step 2 comprises a first data length, which may be made up of a certain number of bits or alphanumerical characters. With a private key formed of 1024 bits, or 2048 bits, it is possible to obtain a first authenticator formed of 171 alphanumerical characters, or 342 alphanumerical characters by distinguishing between upper case and lower case letters or symbols. As it is necessary to reduce to a minimum the coded mark or indication to be placed on the horological or jewelry product, so as to avoid detracting from its aesthetic appearance, this first authenticator cannot be placed directly on the product to be marked. Even by converting said first authenticator into a two dimensional barcode, it cannot be sufficiently reduced in size to be placed on said product, since it must be possible for the barcode to be easily read using a standard digital barcode reader on the market, or under a magnifying glass. The surface available on the product for an authenticator is in theory only several mm².

This first authenticator can however be marked like an identifier on the card accompanying the product being sold at step 7. It may be on the card in the form of a series of alphanumerical characters and/or a two dimensional barcode obtained from the conversion of the first authenticator. The card may also comprise, in addition to the first authenticator and the identifier, various data relating to the operation of the watch and to a manufacturing history also converted into a two dimensional barcode matrix.

With this first authenticator marked on the card, it is possible, with the public key of the asymmetrical algorithm, to find the initial identifier for a first authentication check of the product. In order to do this, a bank type calculator instrument or a software data support for a computer (CD) can be used. The public key is stored in the instrument or in the support for a calculation using the same asymmetrical algorithm that was used for encrypting the identifier. The identifier obtained from the first authenticator decryption operation is then compared to the identifier marked on the card or to the identifier printed or etched on the product.

If the identifier is printed or etched on the product, it is always possible, if the card is lost, to make a request to the parent company or authentication center in order to obtain the first authenticator. The parent company or the authentication center has a data base of the marked products that have been manufactured and sold, and the calculation software using one or more algorithms with pair of private and public keys. The transfer of this data by the parent company can be achieved by a line transmission means or by email or post for example.

In order to reduce the size of the coded mark while reinforcing the security thereof, a second mathematical operation is carried out to encrypt the first authenticator using a new standard Hash type mathematical function, like for example the MD5 or SHA at step 3. A second authenticator is thereby obtained on the basis of the first authenticator with a first long data length. This second authenticator comprises a second data length that is much shorter than the first data length of the first authenticator. The second data length can be formed of 128 bits or 160 bits of binary characters, which are represented by 21 or 26 alphanumerical characters for example.

Even with a second authenticator of reduced data length, the probability of obtaining two identical second authenticators from the first two different authenticators is extremely low (around 10⁻³⁹). This second authenticator is thus a practically unique mathematical representation, which has been encoded with a high level of security, but with a smaller number of characters. Consequently, it is better suited for marking a product of small size. Owing to this second mathematical encryption operation to obtain the second authenticator, this complicates any attempt at counterfeiting by persons of ill intent.

This second authenticator could be placed directly as the coded mark on the product to be coded. However, according to the invention, this second authenticator, which is composed for example of a reduced series of alphanumerical characters, is converted into a coded image as the coded mark or indication at step 4. This coded image is preferably a two dimensional barcode which is of relatively small dimensions. This two dimensional barcode representative of the second authenticator can be easily placed on the product as a coded mark. The surface of this barcode can be less than 1 mm², for example 0.36 mm² without detracting from the aesthetic appearance of the luxury product on which it is placed. Even with such reduced dimensions, the barcode can be read without any problem by a standard digital barcode reader or using a magnifying glass.

The barcode representative of the second authenticator can be printed, stamped to form an imprint or etched into the material of the horological product, or by any other indelible marking means at step 5. Etching can be achieved using a laser beam of a laser apparatus taking account also of the surface state of the product to be marked. The wavelength, power, and the focussing optics can be set in the laser apparatus in order to etch the barcode with very small dimensions in the horological product or jewels. Moreover, the surface of the product to be etched can be worked locally to improve the aesthetic appearance, and the legibility of the barcode.

A complementary signature to the coded mark can also be obtained by programming a variable etch depth and/or a determined etch angle in the laser apparatus. In this manner, during a read operation by a laser beam coded mark reader, said signature belonging to the laser marking apparatus can be determined in addition to simply reading the two dimensional barcode. In this manner, increased security can be obtained for authenticating the luxury product.

The two dimensional barcode representative of the second authenticator cannot be directly reproduced simply by knowing the identifier, since normally it is only the parent company or authentication center which is able to reproduce it for increased security. In order to do this, it is necessary to know the private key(s) used in the encryption algorithm and the Hash type function in order to obtain the second authenticator to be converted.

It should also be noted that if the identifier is the same for all of the products of one manufacturer, then all of these products bear the same coded mark or indication obtained by the method according to the invention. This mark will then be the manufacturer's encrypted seal. However, for different manufacturers having different private keys for the same asymmetrical algorithm, even if the identifier is identical, the coded mark obtained will be different as a function of a different encryption key. In practice, for each of the manufacturers, the identifier is different from one product to another particularly for luxury goods. Consequently, the coded mark or indication will be different for each of the products manufactured, which also allows data concerning production reporting and status control to be supplied for each of the manufacturers.

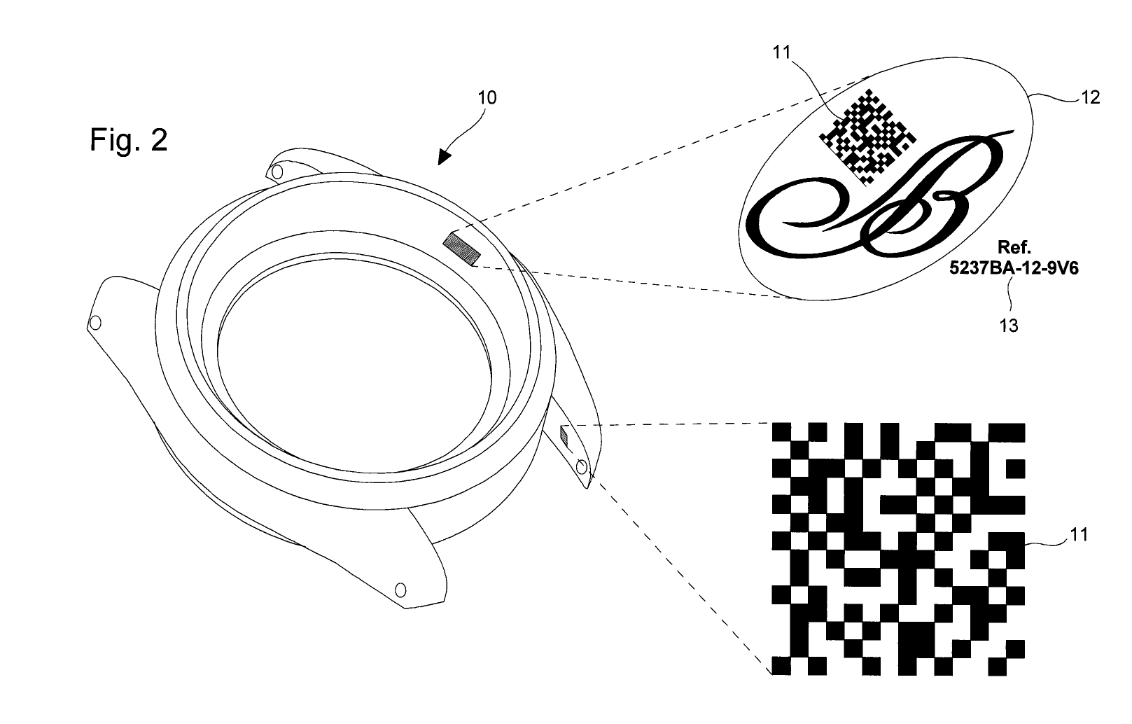

An example of a code marking a product of small size is shown in FIG. 2. The marked product is a wristwatch case 10. In order to do this, a first two dimensional barcode 11, representative of the second converted authenticator, can be placed on an external part of the case, for example between the horns of the case. In this manner, the barcode can be hidden by one end of the wristband mounted between the horns.

A second two dimensional barcode 11 from the conversion of the second authenticator and/or a designation of the watch brand can also be placed on an inner part of the case. This second barcode can consequently be different from the first barcode. This second barcode, as the coded mark, can be combined with a logo 12 of the watch brand.

An imprint of the coded mark combined with the watch brand logo can be made in the material of the inner part of the case. Moreover, the serial number 13, as the identifier, can complete coded mark 11 and logo 12 of the watch brand to form a coded imprint. This type of coded mark can also be made on the watch movement, on the watch dial, on the time indicating hands, and even on any other component of the watch. Of course, each barcode, the watch brand logo and the serial number can be printed or etched in the material of the case.

From the description that has just been given multiple variants of the method for coded marking of a product of small size can be devised by those skilled in the art without departing from the scope of the invention defined by the claims. The two dimensional barcode from conversion of the second authenticator can be replaced by any other coded image provided that the coded image can be easily read for example using a laser beam, such as a laser beam of a reader apparatus. The identifier can comprise a distinctive horological or jewelry brand sign.

1-12. (canceled)

13. A method of coded marking of a horological or jewelry product for authenticating the same, said method consisting in carrying out a first mathematical operation of encrypting an identifier of the product to be marked using a specific security algorithm key to obtain a first authenticator, wherein the method also includes steps of:
encrypting the first authenticator of a first data length into a second authenticator using a second mathematical operation using a Hash type function, the second authenticator, which does not allow the identifier to be found directly, comprising a second data length shorter than the first data length,
converting the second authenticator into a coded image, and
placing the coded image on the product as the coded mark.

14. The method according to claim 13, wherein the first mathematical encryption operation provides a first authenticator whose first data length comprises a first series of binary characters, which is represented by a first number of alphanumerical characters, and wherein the second mathematical operation using the Hash type function provides a second authenticator whose second data length comprises a second series of binary characters, which is represented by a second number of alphanumerical characters between 5 and 20 times smaller than the first number of alphanumerical characters of the first authenticator.

15. The method according to claim 13, wherein the first mathematical operation for encrypting the identifier, which is a serial number of the product to be marked, into a first authenticator is achieved using a private key of an asymmetrical algorithm with a pair of private and public keys, the first number of characters of the first authenticator obtained being for example 171 or 342 alphanumerical characters, and wherein the second mathematical operation provides a second authenticator represented by a second number of alphanumerical characters equal to 21 or 26 alphanumerical characters for example.

16. The method according to claim 13, wherein the second authenticator is converted into a two dimensional barcode to be placed on a surface of the product to be marked less than 1 mm², preferably close to 0.36 mm² so as to be able to be easily read using a digital barcode reader.

17. The method according to claim 16, wherein the barcode is etched into the material of the product to be marked using a laser beam of a laser apparatus.

18. The method according to claim 17, wherein a complementary signature to the laser beam etched coded mark can also be obtained by programming the laser apparatus in order to obtain a variable etch depth or a determined etch angle that can be detected by a digital laser beam reader.

19. The method according to claim 13, for which the product to be marked is a watchcase, a watch movement, a watch dial or a time indicating hand, wherein the coded image is placed on said product in combination with the identifier, which is a serial number of the product and/or a designation of the horological product brand.

20. The method according to claim 19, wherein the coded image is placed on said product in combination with the identifier and a distinctive sign of the horological product brand, the assembly formed by the coded image, the identifier and the distinctive sign preferably being stamped in the material of the product.

21. The method according to claim 19, for which the horological product is a watchcase fitted with horns for securing a wristband, wherein a first coded image defined by a two dimensional barcode is placed on an outer part of the case between the horns of the case so as to be hidden by one end of the wristband secured between said horns, and wherein a second coded image identical to or different from the first coded image is placed on an inner part of the case in combination with the identifier and the distinctive sign of the case brand.

22. A horological or jewelry product marked using the coded marking method according to claim 13, wherein it includes over at least one surface a coded image as the coded mark defined as a two dimensional barcode obtained by a first mathematical operation of encrypting an identifier using one key of a specific security algorithm, and by a second mathematical operation using a Hash type function on a first authenticator obtained after the first mathematical operation.

23. The horological or jewelry product according to claim 22, wherein it is a watchcase with horns for securing a wristband, a watch movement, a watch dial or a time indicating hand, and wherein the two dimensional barcode is etched or stamped into the material of the product.

24. The horological or jewelry product according to claim 23, wherein the product is a watchcase where a first two dimensional barcode is placed on an outer part of the case between the horns of the case so as to be hidden by one end of the wristband secured between said horns, and wherein a second two dimensional barcode identical to or different from the first barcode is placed on an inner part of the case in combination with the identifier and a distinctive sign of the case brand.

25. The method according to claim 20, for which the horological product is a watchcase fitted with horns for securing a wristband, wherein a first coded image defined by a two dimensional barcode is placed on an outer part of the case between the horns of the case so as to be hidden by one end of the wristband secured between said horns, and wherein a second coded image identical to or different from the first coded image is placed on an inner part of the case in combination with the identifier and the distinctive sign of the case brand.
